(19) United States
(12) Patent Application Publication
(10) Pub. No.: US 2013/0034108 A1
(43) Pub. Date: Feb. 7, 2013

(54) System and Method for Communications Network Configuration

(71) Applicants: John Kaippallimalil, Richardson, TX (US); Yangsong Xia, Nanjing (CN); Spencer Dawkins, Allen, TX (US)

(72) Inventors: John Kaippallimalil, Richardson, TX (US); Yangsong Xia, Nanjing (CN); Spencer Dawkins, Allen, TX (US)

(73) Assignee: FutureWei Technologies, Inc., Plano, TX (US)

(21) Appl. No.: 13/537,024

(22) Filed: Jun. 28, 2012

Related U.S. Application Data
(60) Provisional application No. 61/502,274, filed on Jun. 28, 2011.
(60) Provisional application No. 61/504,028, filed on Jul. 1, 2011.

(51) Int. Cl. H04L 12/66; H04L 12/56

(52) U.S. Cl. 370/401

(57) ABSTRACT

A method for operating a first communications device includes transmitting a provisioned network list to an access router, and receiving a logical router interface address for each network in the provisioned network list. The method also includes transmitting a first message to one of the logical router interface addresses corresponding to a first selected network, receiving a first address prefix for a first gateway router of the first selected network, and transmitting a first packet to a second communications device, the first packet including the first address prefix as a source prefix.

This application claims the benefit of U.S. Provisional Application No. 61/502,274, filed on Jun. 28, 2011, entitled “System and Method for Stateless Auto-Configuration,” and U.S. Provisional Application No. 61/504,028, filed on Jul. 1, 2011, entitled “System and Method for APN Configuration,” which applications are hereby incorporated herein by reference.

### TECHNICAL FIELD

The present disclosure relates generally to digital communications, and more particularly to a system and method for communications network configuration.

### BACKGROUND

In a cellular communications network, a base station (also commonly referred to as a base transceiver station, a NodeB, an evolved NodeB, controller, communications controller, and the like) serves mobile stations (also commonly referred to as terminals, user equipments, subscribers, users, mobiles, hosts, and the like) via an air or radio interface with a coverage area referred to as a cell. Examples of cellular communications networks include technical standards such as Global System for Mobile communications (GSM), American Mobile Phone System (AMPS), Digital AMPS (DAMPS), Wideband Code Division Multiple Access (WCDMA), Universal Mobile Telecommunications System (UMTS), CDMA 2000, and the like.

A heterogeneous communications network is a communications network connecting devices with different operating systems and/or protocols. In wireless communications network, a heterogeneous network is a network using different access technologies. As an example, a wireless communications network that provides service through a wireless local area network (LAN) and is able to maintain service when switching to a cellular communications network can be considered as a wireless heterogeneous communications network.

### SUMMARY OF THE DISCLOSURE

Example embodiments of the present disclosure which provide a system and method for communications network configuration.

In accordance with an example embodiment of the present disclosure, a method for operating a first communications device is provided. The method includes transmitting, by the first communications device, a provisioned network list to an access router. The method also includes receiving, by the first communications device, a logical router interface address for each network in the provisioned network list, and transmitting, by the first communications device, a first message to one of the logical router interface addresses corresponding to a first selected network. The method further includes receiving, by the first communications device, a first address prefix for a first gateway router of the first selected network, and transmitting, by the first communications device, a first packet to a second communications device, the first packet including the first address prefix as a source prefix.

In accordance with another example embodiment of the present disclosure, a method for operating an access router is provided. The method includes receiving, by the access router, a provisioned network list from a first communications device and assigning, by the access router, a logical router interface for each network in the provisioned network list. The method also includes transmitting, by the access router, a logical router interface address for each network in the provisioned network list, and receiving, by the access router, a first message addressed to a first one of the logical router interface addresses corresponding to a selected network. The method further includes determining, by the access router, a first gateway router associated with the selected network, and transmitting, by the access router, a first address prefix of the first gateway router to the first communications device.

In accordance with another example embodiment of the present disclosure, a method for operating a first communications device is provided. The method includes requesting, by the first communications device, a first address prefix of a first gateway router correlating to a first specific network from an access router, and storing, by the first communications device, an association between the first address prefix and the first specific network in a memory when received from the access router. The method also includes receiving, by the first communications device, a message from the access router, the message including a second address prefix of the first gateway router for the first specific network, and searching, by the first communications device, the memory for the first address prefix that matches the second address prefix to determine the first specific network to use for transmissions. The method further includes transmitting, by the first communications device, a packet to a second communications device via the first specific network.

In accordance with another example embodiment of the present disclosure, a method for operating an access router is provided. The method includes receiving, by the access router, a first message from a first communications device, the first message includes a specific network that the first communications device is to communicate with. The method also includes transmitting, by the access router, specific network information and a first address prefix of a gateway router correlating to the specific network to the first communications device, and transmitting, by the access router, a message to the first communications device, the message including a second address prefix of the gateway router for the specific network.

In accordance with another example embodiment of the present disclosure, a first communications device is provided. The first communications device includes a transmitter and a receiver operatively coupled to the transmitter. The transmitter transmits a provisioned network list to an access router, transmits a first message to one of a first logical router interface address out of a plurality of logical router interface addresses, the first logical router interface address corresponding to a first selected network, and transmits a first packet to a second communications device, the first packet including a first address prefix as a source prefix. The receiver receives the plurality of logical router interface addresses, where each logical router interface address corresponds to a network in the provisioned network list, and receives the first address prefix for a first gateway router of the first selected network.

In accordance with another example embodiment of the present disclosure, an access router is provided. The access router includes a receiver, a processor operatively coupled to the receiver, and a transmitter operatively coupled to the processor. The receiver receives a provisioned network list from a first communications device, and receives a message addressed to a first one of a plurality of logical router interface addresses corresponding to a selected network. The processor assigns a logical router interface to each network in the provisioned network list, and determines a first gateway router associated with the selected network. The transmitter transmits the plurality of logical router interface addresses for the provisioned network list, and transmits a first address prefix for the first gateway router to the first communications device.

In accordance with another example embodiment of the present disclosure, a first communications device is provided. The first communications device includes a processor, a receiver operatively coupled to the processor, and a transmitter operatively coupled to the processor. The processor requests a first address prefix of a first gateway router correlating to a first specific network from an access router, stores an association between the first address prefix and the first specific network in a memory when received from the access router, and searches the memory for the first address prefix that matches a second address prefix to determine the first specific network to use for transmissions. The receiver receives a first message from the access router, the message includes the association between the first address prefix and the first specific network, and receives a second message from the access router, the second message including the second address prefix of the first gateway router for the first specific network. The transmitter transmits a packet to a second communications device via the specific network.

In accordance with another example embodiment of the present disclosure, an access router is provided. The access router includes a receiver, a transmitter, and a processor operatively coupled to the receiver and to the transmitter. The receiver receives a first message from a first communications device, the first message includes a specific network that the first communications device is to communicate with. The transmitter transmits specific network information and a first address prefix of a gateway router correlating to the specific network to the first communications device, and transmits a message to the first communications device, the message including a second address prefix of the gateway router for the specific network. The processor resolves the gateway router for the specific network.

One advantage of an embodiment is that example embodiments allow user equipment receiving access through non-Third Generation Partnership Project (3GPP) networks to specify a network that they wish to use.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example heterogeneous communications network according to example embodiments described herein;

FIG. 2 illustrates an example heterogeneous communications network where logical interfaces are highlighted according to example embodiments described herein;

FIG. 3 illustrates an example message exchange diagram where a host transmits a message to a specific router interface to establish a connection with an APN according to example embodiments described herein;

FIG. 4a illustrates an example flow diagram of operations occurring in a host as the host establishes a connection with an APN by transmitting a message to a specific router interface according to example embodiments described herein;

FIG. 4b illustrates an example flow diagram of operations occurring in an access router as a host establishes a connection with an APN by transmitting a message to a specific router interface according to example embodiments described herein;

FIG. 5 illustrates an example message exchange diagram where a host establishes connections to multiple APNs by transmitting messages to specific router interfaces according to example embodiments described herein;

FIG. 6 illustrates an example message exchange diagram where an access router provides information about associations between logical router interfaces and APNs to a host according to example embodiments described herein;

FIG. 7a illustrates an example flow diagram of operations occurring in a host as the host establishes a connection with an APN after receiving a hint from an access router according to example embodiments described herein;

FIG. 7b illustrates an example flow diagram of operations occurring in an access router as a host establishes a connection with an APN after receiving a hint from the access router according to example embodiments described herein;

FIG. 8 illustrates an example message exchange diagram where a host establishes connections to multiple APNs after receiving a hint from an access router according to example embodiments described herein;

FIG. 9 illustrates an example first communications device according to example embodiments described herein; and

FIG. 10 illustrates an example second communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to communications network configuration. For example, at a host, the host receives logical router interface addresses for each of its provisioned networks. The host selects one of the provisioned networks and transmits a message addressed to the logical router interface address of the logical router interface associated with the selected provisioned network to configure its connection to the selected provisioned network. For example, at a host, the host receives an address prefix for a network and stores the address prefix in a memory. The host also receives a later address prefix, which it uses to search its stored address prefixes to determine a network associated with the later address prefix.

The present disclosure will be described with respect to example embodiments in a specific context, namely a heterogeneous communications network that includes 3GPP compliant communications networks and non-3GPP compliant communications networks, such as IEEE 802.11, IEEE 802.16, WiMAX, and the like. The disclosure may also be applied, however, to other heterogeneous communications networks that combine a first communications network that permits user equipment to specify a network that they wish to use with a second communications network that does not allow user equipment to specify a network that they wish to use.

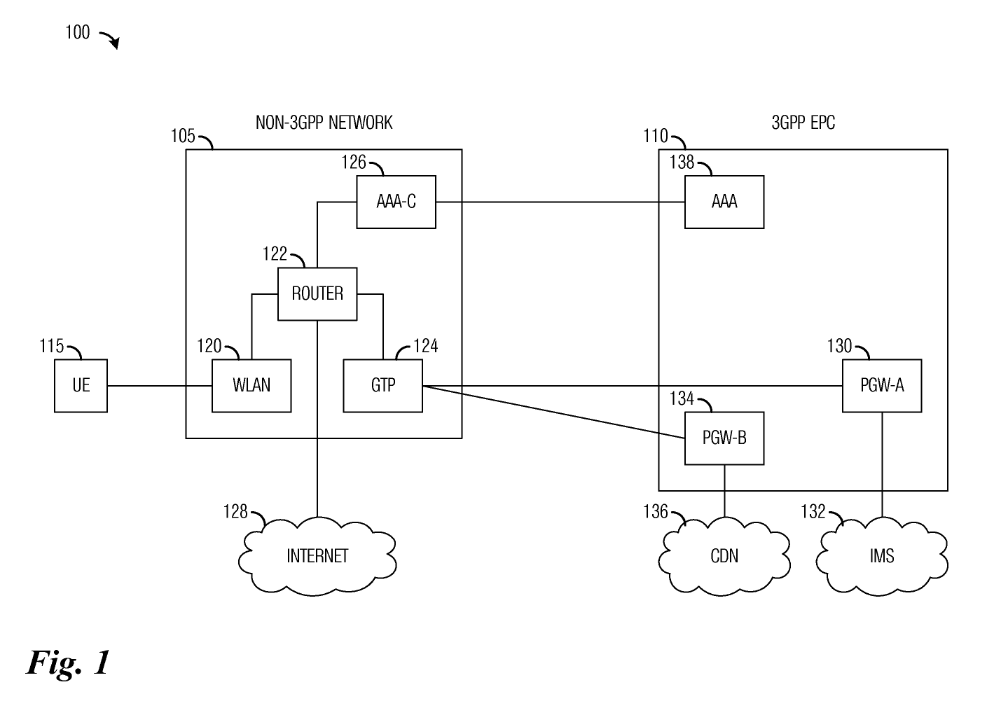

FIG. 1 illustrates a heterogeneous communications network 100. As shown in FIG. 1, heterogeneous communications network 100 includes a non-3GPP communications network 105 coupled to a 3GPP evolved packet core (EPC) 110. A user equipment (UE) 115 may be connected to non-3GPP communications network 105 by way of a wireless local area network (WLAN) 120. Packets to UE 115 and from UE 115 are routed by a router 122. A General Packet Radio Service (GPRS) Tunneling Protocol (GTP) unit 124 may manage tunnels from non-3GPP communications network 105 to and from 3GPP EPC 110. An Authentication, Authorization, and Accounting Client (AAA-C) 126 may be used to interface with an AAA server 138 to authenticate, authorize, as well as maintain accounting information for UE, such as UE 115, coupled to non-3GPP communications network 105. Non-3GPP communications network 105 may allow UE 115 to access a network, such as the Internet 128. It is noted that a network may also be referred to as an Access Point Name (APN).

In order to access other types of networks (APNs), such as a Content Delivery Network (CDN), an Internet Protocol (IP) Multimedia System (IMS), and the like, UE 115 may use 3GPP EPC 110. 3GPP EPC 110 includes a first Packet Data Network Gateway (PGW) “PGW-A” 130 to serve as an entry and/or exit point for a first network, such as an IMS 132, and a second PGW “PGW-B” 134 to serve as an entry and/or exit point for a second network, such as a CDN 136. 3GPP EPC 110 also includes AAA server 138 to authenticate, authorize, as well as maintain accounting information for UE accessing networks in 3GPP EPC 110.

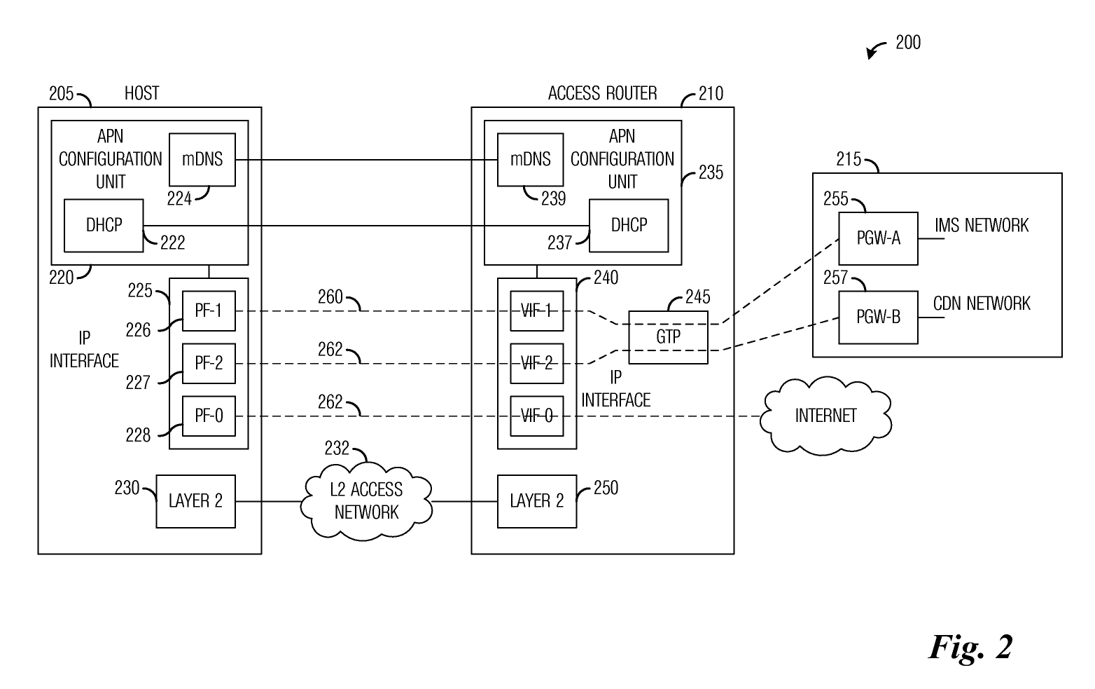

FIG. 2 illustrates a heterogeneous communications network 200 where logical interfaces are highlighted. Heterogeneous communications network 200 includes a host 205, an access router 210, and a 3GPP EPC 215. It is noted that a UE is another term for host 205. It is also noted that access router 210 is a part of a non-3GPP communications network. Host 205 may include an APN configuration unit 220 that may be responsible for configuring host 205 for communicating with specific APNs. As an example, APN configuration unit 220 may be used to configuring address prefixes of routers, e.g., access routers, PGW, and the like, of APNs. APN configuration unit 220 may use any of a variety of configuration protocols, such as Dynamic Host Configuration Protocol (DHCP), IEEE 802.1u, and the like, to configure host 205. As an example, if DHCP is used as the configuration protocol, APN configuration unit 220 may include a DHCP unit 222 and a multicast-Domain Name Service (mDNS) server 224.

Host 205 may also include an IP interface 225 that may be responsible for interacting with different packets to and from access router 210 as well as different APNs. As shown in FIG. 2, IP interface 225 includes three interfaces, with one interface for each of three APNs that host 205 is capable of communicating with. As an example, Prefix-1 (PF-1) 226 interfaces with an IMS network, PF-2 227 interfaces with a CDN network, and PF-0 228 interfaces with the Internet. A layer-2 unit 230 may provide layer-2 connectivity with access router 210 through a layer-2 access network 232. It is noted that IP interface 225 may support any number of interfaces, e.g., one, two, three, four, five, and the like, and that three interfaces is merely an illustrative example.

Access router 210 may include an APN configuration unit 235. APN configuration unit 235 may operate in conjunction with APN configuration unit 220 to configure access router 210. As an example, if DHCP is used as the configuration protocol, APN configuration unit 235 may include a DHCP unit 237 and a multicast-Domain Name Service (mDNS) server 239. Access router 210 also includes an IP interface 240 that may be responsible for interacting with different packets to and from host 205 as well as different APNs. As shown in FIG. 2, IP interface 240 may include a router interface for each of the three APNs that host 205 is capable of communicating with. As an example, Virtual Interface-1 (VIF-1) interfaces with the IMS network, VIF-2 interfaces with the CDN network, and VIF-0 interfaces with the Internet. It is noted that IP interface 240 may support any number of interfaces, e.g., one, two, three, four, five, and the like, and that three interfaces is merely an illustrative example.

It is noted that each router interface has a link local address, for example, VIF-1, VIF-2, VIF-0, and the like, to which host 205 may be able to send messages, such as a router solicitation. Alternatively, the router interfaces may be addresses selected from well-known 3GPP router multicast groups.

A layer-2 unit 250 may provide layer-2 connectivity with host 205. A GTP unit 245 may be responsible for managing tunnels to and from 3GPP EPC 215. 3GPP EPC 215 may include PDN gateways to APNs coupled to it, such as PGW-A 255 to the IMS network and PGW-B 257 to the CDN network. Also shown in FIG. 2 are dashed lines representative of connections between host 205 and access router 210 and 3GPP EPC 215. As an example, dashed line 260 connects host 205 to the IMS network, dashed line 262 connects host 205 to the CDN network, while dashed line 262 connects host 205 to the Internet.

It is noted that when the APN is connected to 3GPP EPC 215, the PGW may act as a gateway router. On a network to network interface between access router 210 and a PGW, such as PGW-A 255 and PGW-B 257, GTP or Proxy Mobile Internet Protocol version 6 (IPv6) (PMIP) may be used to request IPv6 addresses and packets may be tunneled between access router 210 and the PGW using a GTP-U tunnel or a PMIP tunnel.

It may be possible for a host to specify an APN once it knows the address, e.g., the link local address, of a router interface for the APN at an access router. Once the host knows the address of the router interface for the APN that it wishes to use, the host may send a message, for example, a router solicitation, to the router interface at its address to configure a connection to the APN.

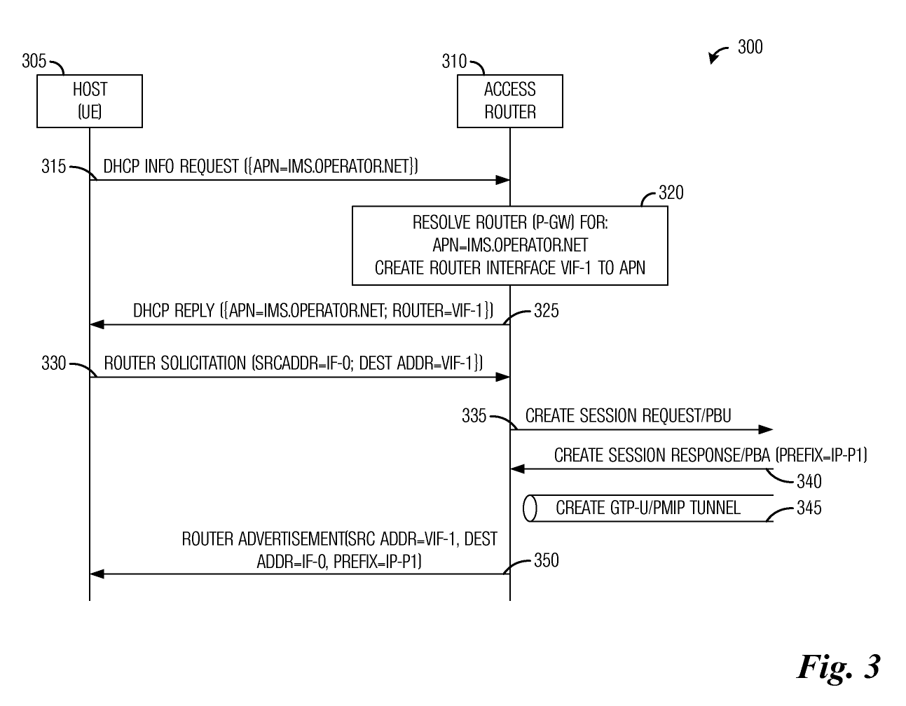

FIG. 3 illustrates a message exchange diagram 300 where a host transmits a message to a specific router interface to establish a connection with an APN. Message exchange diagram 300 includes messages exchanged between a host 305 and an access router 310.

Message exchange diagram 300 may begin with host 305 transmitting a configuration message, such as a DHCP information request message, to access router 310 requesting an address of an APN(s) (shown as event 315). The configuration message may include a list of one or more APNs that host 305 is provisioned with, i.e., a list of compatible APNs or similarly, a provisioned network list. It is noted that instead of DHCP, a multicast-DNS query may be used by host 305 if host 305 does not support DHCP.

Access router 310 may compare the APN(s) provided by host 305 against a list of APNs that host 305 is allowed to access to determine if the APN(s) is consistent (block 320). In other words, access router 310 compares the APN(s) that host 305 wishes to access with a list of APN(s) that host 305 is permitted to access. Access router 310 may establish a logical router interface, e.g., link local address or an address from a 3GPP router multicast group, for each APN, thereby forming a one to one association between each logical router interface and each APN. Access router may transmit a configuration response message, such as a DHCP reply message, containing addresses of the logical router interface(s) to host 305 (shown as event 325).

Host 305 may select a specific APN to attach to and configure an IPv6 prefix for the APN by transmitting a message, e.g., a router solicitation, to a logical router interface for the specific APN (shown as event 330). In other words, host 305 transmits the message directly to the logical router interface responsible for the specific APN rather than to all logical router interfaces.

Access router 310 may use the previously established one to one association between the logical router interface and the APN to determine a gateway router for the APN. As an example, access router 310 may resolve the APN with a 3GPP DNS lookup and obtain an address of the gateway router. Access router 310 may use an address prefix of the gateway router for the APN and/or establish a session with the gateway router (shown as events 335 and 340) as well as establish a tunnel with the gateway router (shown as event 345). Access router 310 may transmit a message, e.g., a router advertisement, including the address prefix of the gateway router to host 305 (shown as event 350). As an example, the address prefix of the gateway router may be used as a source prefix. The use of the address prefix of the gateway router as the source prefix provides host 305 with the source prefix to append to an address of a specific service, thereby ensuring that messages so addressed are routed to the gateway router, which in turn, routes the message to the specific service.

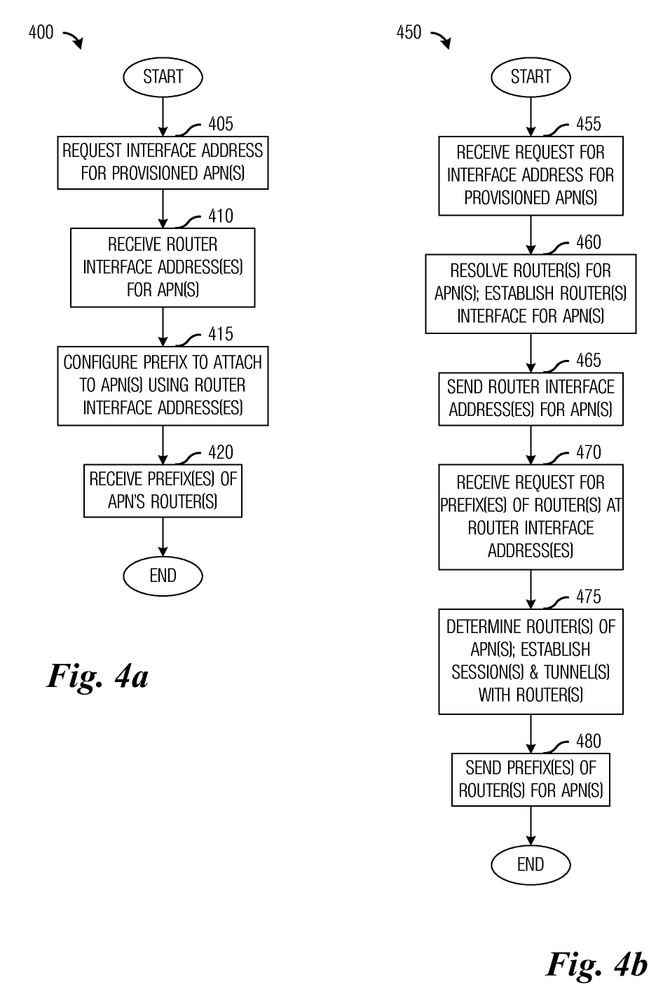

FIG. 4a illustrates a flow diagram of operations 400 occurring in a host as the host establishes a connection with an APN by transmitting a message to a specific router interface. Operations 400 may be indicative of operations occurring in a host, such as host 205, as the host establishes a connection to an APN by transmitting a message to a specific router interface.

Operations 400 may begin with the host requesting addresses of an APN(s) that it is provisioned with (block 405). The host may request the address by transmitting a DHCP information request message or a similar message in a different configuration protocol. The host may provide a provisioned network list or similarly, a list of compatible APN(s). The host may receive addresses, e.g., logical router addresses, of the APN(s) (block 410). The addresses may be received in a DHCP reply message or a similar message in a different configuration protocol. The host may select an APN to attach to and configure an IPv6 prefix for the APN by transmitting a message, e.g., a router solicitation, to a logical router interface for the specific APN (block 415). The host may receive an address prefix of a gateway router of the specific APN (block 420).

FIG. 4b illustrates a flow diagram of operations 450 occurring in an access router as a host establishes a connection with an APN by transmitting a message to a specific router interface. Operations 450 may be indicative of operations occurring in an access router, such as access router 210, as a host establishes a connection to an APN by transmitting a message to a specific router interface.

Operations 450 may begin with the access router receiving a request for addresses of an APN(s) provisioned to the host (block 455). The request may be received in a DHCP information request message or a similar message in a different configuration protocol. The access router may compare the APN(s) provided by the host with a list of APNs that the host is allowed to access or is compatible with and establish a logical router interface, e.g., link local address or an address from a 3GPP router multicast group, for each APN, thereby forming a one to one association between each logical router interface and each APN (block 460). The access router may send addresses, e.g., link local addresses or addresses from a 3GPP router multicast group, to the host (block 465). The addresses may be sent in a DHCP reply message or a similar message in a different configuration protocol.

The access router may receive a message, e.g., a router solicitation, addressed to a logical router interface for an APN selected by the host (block 470). In other words, the host transmits the message directly to the logical router interface responsible for the specific APN rather than to all logical router interfaces. The access router may use the previously established one to one association between the logical router interface and the APN to determine a gateway router for the APN. As an example, the access router may resolve the APN with a 3GPP DNS lookup and obtains an address of the gateway router. The access router may use an address prefix of the gateway router for the APN and establish a session with the gateway router as well as establish a tunnel with the gateway router (block 475). The access router may transmit a message, e.g., a router advertisement, including the address prefix of the gateway router to the host 305 (block 480).

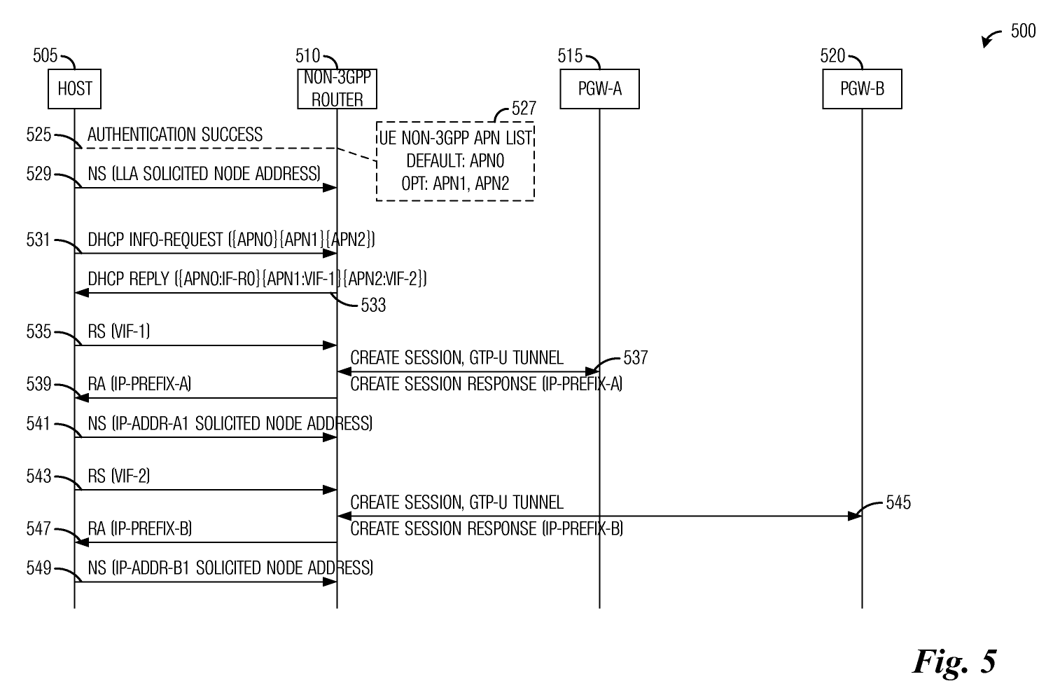

FIG. 5 illustrates a message exchange diagram 500 where a host establishes connections to multiple APNs by transmitting messages to specific router interfaces. Message exchange diagram 500 includes messages exchanged between host 505, non-3GPP router (e.g., access router) 510, PGW-A 515, and PGW-B 520.

Message exchange diagram 500 may begin with access router 510 successfully authenticating host 505 (shown as event 525). Access router 510 may also obtain an APN list for host 505, which may include a default APN (e.g., APN0) and one or more optional APNs (e.g., APN1 and APN2) (shown as event 527). As discussed previously, the APN list may be a list of compatible APNs or similarly, a provisioned network list. Host 505 may perform a network services (NS) duplicate address detection (DAD) procedure on its local link address (shown as event 529).

Host 505 may then configure an APN to router interface mapping by transmitting a DHCP information request message, for example, to access router 510 with the APNs in the APN list (shown as event 531). The DHCP information request message or a similar message in a different configuration protocol may request addresses for the APNs. Access router 510 may reply with a DHCP reply message, for example, to host 505 with addresses of logical router interfaces for the APNs (shown as event 533).

Host 505 may select a first specific APN to attach to and configure an IPv6 prefix for the APN by transmitting a message, e.g., a router solicitation, to a logical router interface for the specific APN (shown as event 535). In other words, host 505 transmits the message directly to the logical router interface responsible for the first specific APN rather than to all logical router interfaces.

Access router 510 may use the previously established one to one association between the logical router interface and the first specific APN to determine a gateway router for the first specific APN. As an example, access router 510 may resolve the first specific APN with a 3GPP DNS lookup and obtains an address of the gateway router, e.g., PGW-A 515. Access router 510 may use an address prefix of the gateway router for the first specific APN and establish a session with the gateway router as well as establish a tunnel with the gateway router (shown as event 537). Access router 510 may transmit a message, e.g., a router advertisement, including the address prefix of the gateway router to host 505 (shown as event 539). Host 505 may perform an NS DAD procedure on the address prefix of the gateway router (shown as event 541).

Host 505 may select a second specific APN to attach to and configure an IPv6 prefix for the APN by transmitting a message, e.g., a router solicitation, to a logical router interface for the specific APN (shown as event 543). In other words, host 505 transmits the message directly to the logical router interface responsible for the second specific APN rather than to all logical router interfaces.

Access router 510 may use the previously established one to one association between the logical router interface and the second specific APN to determine a gateway router for the second specific APN. As an example, access router 510 may resolve the second specific APN with a 3GPP DNS lookup and obtains an address of the gateway router, e.g., PGW-B 520. Access router 510 may use an address prefix of the gateway router for the second specific APN and establish a session with the gateway router as well as establish a tunnel with the gateway router (shown as event 545). Access router 510 may transmit a message, e.g., a router advertisement, including the address prefix of the gateway router to host 505 (shown as event 547). Host 505 may perform an NS DAD procedure on the address prefix of the gateway router (shown as event 549). It is noted that the discussion of message exchange diagram 500 utilizes specific examples of APNs and gateway routers. However, the specific examples are simply illustrative examples used to facilitate discussion. Therefore, their use should not be construed as being limiting to the scope or the spirit of the example embodiments.

It may be possible for an access router to provide information, i.e., hints, about associations between logical router interfaces and APNs to a host. The host may then later use the information regarding the associations between the logical router interfaces and the APNs to specify a specific APN to connect to.

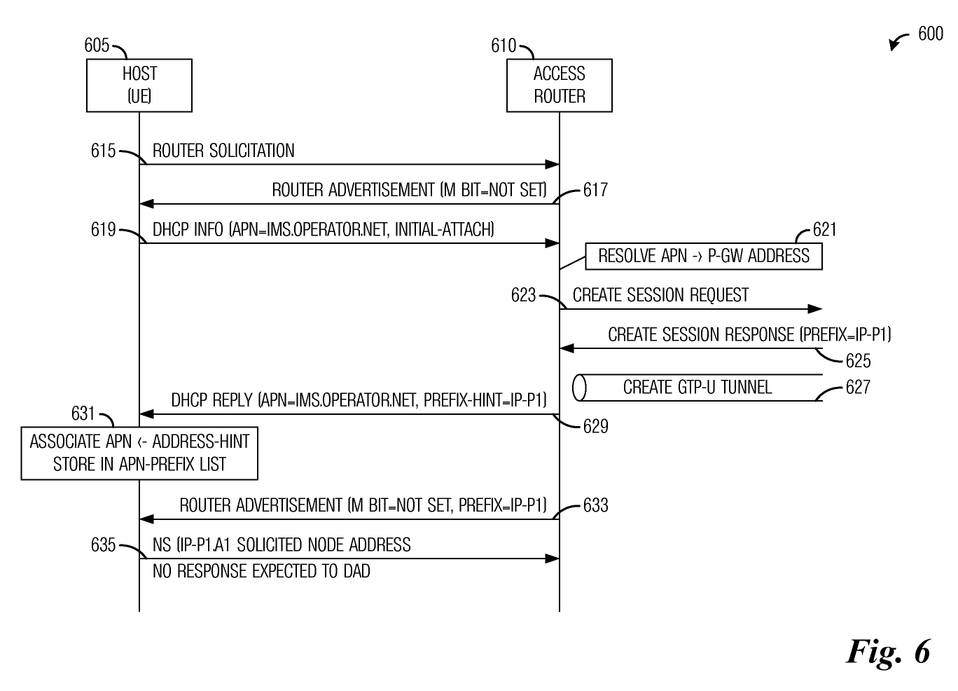

FIG. 6 illustrates a message exchange diagram 600 where an access router provides information about associations between logical router interfaces and APNs to a host. Message exchange diagram 600 includes messages exchanged between a host 605 and an access router 610.

Message exchange diagram 600 may begin with host 605 transmitting a message, such as a router solicitation, to discover a configuration mechanism(s) supported by access router 610 (shown as event 615). Access router 610 may reply with a message, e.g., a router advertisement, with an indication that it supports stateless auto-configuration (shown as event 617). As an example, the message may include a flag, e.g., an M bit, which is set to a value representing stateless auto-configuration. The flag being set to stateless auto-configuration may indicate to host 605 that it should perform stateless auto-configuration.

Host 605 may initiate a stateless auto-configuration by transmitting a message, e.g., a DHCP information request message, to access router 610 with an APN that host 605 is to communicate with (shown as event 619). As an example, the DHCP information request message or a similar message in a different configuration protocol may include the APN and/or an option request option containing the APN. Access router 610 may resolve an address for a PGW for the APN specified by host 605 (shown as event 621). Access router 610 may also establish either a GTP or a PMIPv6 tunnel to the PGW (shown as events 623, 625, and 627).

Access router 610 may transmit a message, such as a DHCP reply message, including a hint, i.e., information about an association between the APN selected by host 605 and an address prefix of the PGW for the APN to host 605 (shown as event 629). The DHCP reply message or a similar message in a different configuration protocol may include the APN as well as the address prefix of the PGW for the APN. Host 605 may associate the address prefix with the APN and store the association in an APN list in a memory (shown as event 631). As an example, the association may be stored as a look-up table in the memory. It is noted that the association may be stored in many different forms and/or formats. In general, any format that allows searching may be used.

Access router 610 may transmit a message, such as a router advertisement, including the address prefix of the PGW for the APN to host 605 (shown as event 633). Host 605 may compare the address prefix received in the router advertisement with the associations stored in the APN list in the memory. If host 605 finds a match in the APN list, host 605 may associate the address prefix with the APN and continues to configure the interface (shown as event 635). Host 605 may continue to configure the interface by performing an NS DAD procedure to detect duplicate addresses as well as update neighbor caches.

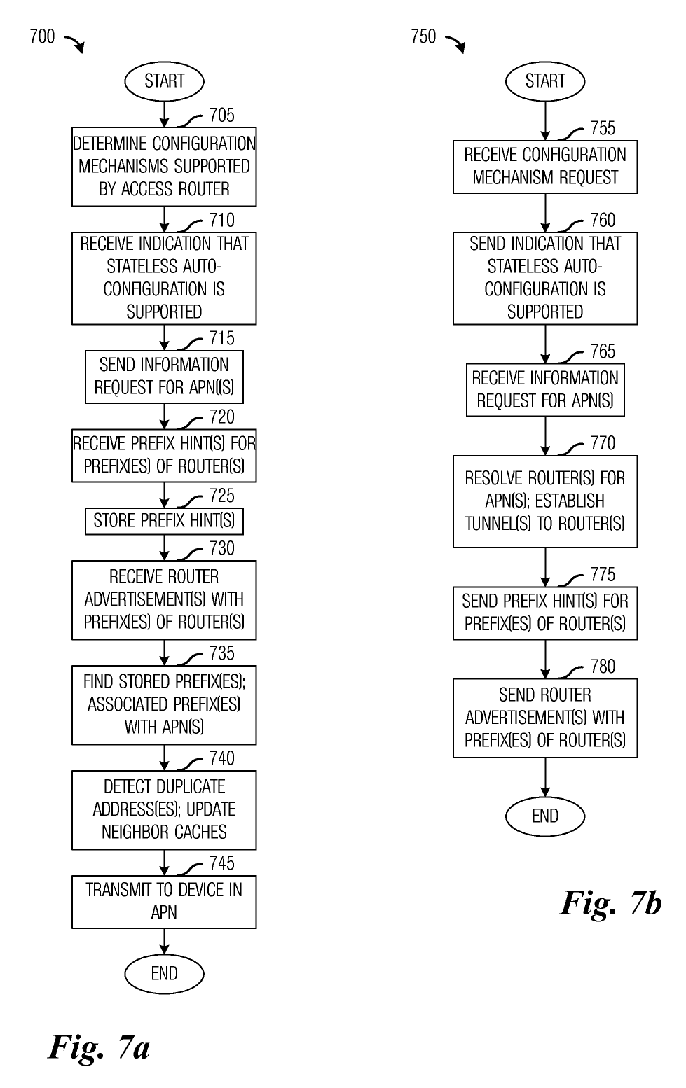

FIG. 7a illustrates a flow diagram of operations 700 occurring in a host as the host establishes a connection with an APN after receiving a hint from an access router. Operations 700 may be indicative of operations occurring in a host, such as host 205, as the host establishes a connection to an APN after receiving a hint from an access router.

Operations 700 may begin with the host transmitting a message, such as a router solicitation, to discover a configuration mechanism(s) supported by the access router (block 705). The host may receive a message, e.g., a router advertisement, with an indication that it supports stateless auto-configuration (block 710). As an example, the message may include a flag, e.g., an M bit, which is set to a value representing stateless auto-configuration. The flag being set to stateless auto-configuration may indicate to the host that it should perform stateless auto-configuration.

The host may transmit a message, e.g., a DHCP information request message, to the access router with an APN that the host is to communicate with (block 715). As an example, the DHCP information request message or a similar message in a different configuration protocol may include the APN and/or an option request option containing the APN. The host may receive a message, such as a DHCP reply message, including a hint, i.e., information about an association between the APN selected by the host and an address prefix of a PGW for the APN (block 720). The DHCP reply message or a similar message in a different configuration protocol may include APN information, such as identifying information for the APN, a name for the APN, and the like, as well as the address prefix of the PGW for the APN. The host may associate the address prefix of the PGW with the APN and store the association in an APN list in a memory (block 725). The association between the address prefix and the APN may include the address prefix and the APN information. It is noted that the address prefix of the PGW may also be stored in the APN list. As an example, the association may be stored as a look-up table in the memory. It is noted that the host may store multiple address prefixes and associations for multiple APNs in the APN list. As an example, if the host is provisioned or compatible with four APNs, the APN list may include an address prefix of a PGW and APN information for each of the four APNs. It is also noted that the association may be stored in many different forms and/or formats. In general, any format that allows searching may be used.

The host may receive a message, such as a router advertisement, including the address prefix of the PGW for the APN (block 730). The host may compare the address prefix received in the router advertisement with the associations stored in the APN list in the memory. If the host finds a match in the APN list, the host may associate the address prefix with the APN (block 735) and continues to configure the interface (block 740). It is noted that the host may transmit a packet to a device using the APN by appending the address prefix associated with the APN to a destination address of the packet. The host may continue to configure the interface by performing an NS DAD procedure to detect duplicate addresses as well as update neighbor caches. Due to the use of point to point links, the address prefix advertised to each host may be different. Therefore, NS DAD may be used to detect duplicate addresses as well as update neighbor caches. A result of the NS DAD may be that only the router interface that is on-link for the host remains. When the host populates the neighbor cache, it may have the router interface for link local address, assigned IP prefix, and the like. Route caches may also have the router interface for link local address, assigned IP prefix, and the like, to forward to any destination, the next hop being the router interface. In other words, NS DAD requests may receive no reply (i.e., there are no duplicates) and the neighbor cache may have the router interface entry. The host may transmit a packet to a device via the APN (block 745)

FIG. 7b illustrates a flow diagram of operations 750 occurring in an access router as a host establishes a connection with an APN after receiving a hint from the access router. Operations 750 may be indicative of operations occurring in an access router, such as access router 210, as a host establishes a connection to an APN after receiving a hint from the access router.

Operations 750 may begin with the access router receiving a message, such as a router solicitation, to discover a configuration mechanism(s) supported by the access router (block 755). The access router may transmit a message, e.g., a router advertisement, with an indication that it supports stateless auto-configuration (block 760). As an example, the message may include a flag, e.g., an M bit, which is set to a value representing stateless auto-configuration. The flag being set to stateless auto-configuration may indicate to the host that it should perform stateless auto-configuration.

The access router may receive a message, e.g., a DHCP information request message, with an APN that the host is to communicate with (block 765). As an example, the DHCP information request message or a similar message in a different configuration protocol may include the APN and/or an option request option containing the APN. The access router may resolve an address for a PGW for the APN specified by the host and also establish either a GTP or a PMIPv6 tunnel to the PGW (block 770).

The access router may transmit a message, such as a DHCP reply message, including a hint, i.e., information about an association between the APN selected by the host and an address prefix of the PGW for the APN to the host (block 775). As an example, the association may include APN information, such as APN name, APN identifying information, and the like, and the address prefix of the PGW. The DHCP reply message or a similar message in a different configuration protocol may include the APN as well as the address prefix of the PGW for the APN. The access router may transmit a message, such as a router advertisement, including the address prefix of the PGW for the APN to the host (block 780).

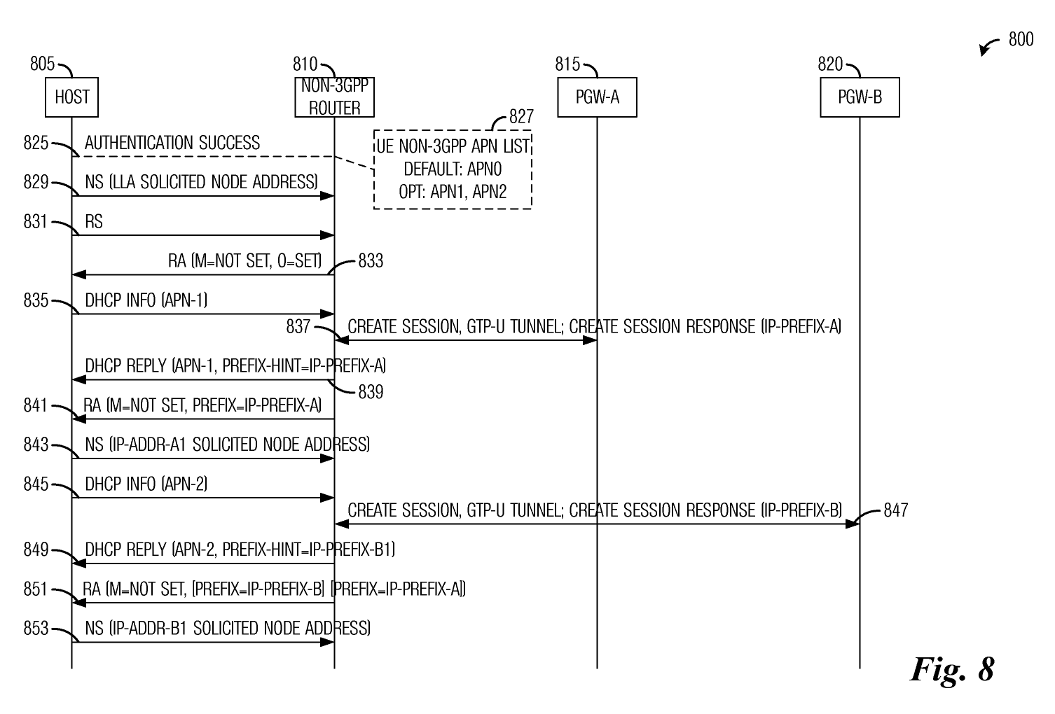

FIG. 8 illustrates a message exchange diagram 800 where a host establishes connections to multiple APNs after receiving a hint from an access router. Message exchange diagram 800 includes messages exchanged between host 805, non-3GPP router (e.g., access router) 810, PGW-A 815, and PGW-B 820.

Message exchange diagram 800 may begin with access router 810 successfully authenticating host 805 (shown as event 825). Access router 810 may also obtain an APN list for host 805, which may include a default APN (e.g., APN0) and/or one or more optional APNs (e.g., APN1 and APN2) (shown as event 827). Host 805 may perform an NS DAD lookup on its local link address (shown as event 829). Host 805 may transmit a message, such as a router solicitation, to access router 810 (shown as event 831). The message may be used to discover which form of router configuration is supported by access router 810, for example.

Access router 810 may transmit a message, such as a router advertisement, with an indication that it supports stateless auto-configuration (shown as event 833). As an example, the message may include a flag, e.g., an M bit, which is set to a value representing stateless auto-configuration. The flag being set to stateless auto-configuration may indicate to host 805 that it should perform stateless auto-configuration.

Host 805 may transmit a message, e.g., a DHCP information request message, to access router 810 with an APN that host 805 is to communicate with, i.e., a first selected APN (shown as event 835). As an example, the DHCP information request message or a similar message in a different configuration protocol may include the first selected APN/or and an option request option containing the first selected APN. Access router 810 may resolve an address for a PGW, e.g., PGW-A 815, for the first selected APN specified by host 805 and also establish either a GTP or a PMIPv6 tunnel to the PGW (shown as event 837).

Access router 810 may transmit a message, such as a DHCP reply message, including a hint, i.e., information about an association between the first selected APN and an address prefix of the PGW for the first selected APN to host 805 (shown as event 839). The DHCP reply message or a similar message in a different configuration protocol may include the first selected APN as well as the address prefix of the PGW for the first selected APN. Host 805 may store the address prefix and the association in an APN list in a memory. Access router 810 may transmit a message, such as a router advertisement, including the address prefix of the PGW for the first selected APN to host 805 (shown as event 841).

Host 805 may compare the address prefix received in the router advertisement with the associations stored in the APN list in the memory. If host 805 finds a match in the APN list, host 805 may associate the address prefix with the first selected APN and continues to configure the interface (shown as event 843). Host 805 may continue to configure the interface by performing an NS DAD to detect duplicate addresses as well as update neighbor caches.

Host 805 may transmit a message, e.g., a DHCP information request message, to access router 810 with an APN that the host is to communicate with, i.e., a second selected APN (shown as event 845). As an example, the DHCP information request message or a similar message in a different configuration protocol may include the second selected APN and/or an option request option containing the second selected APN. Access router 810 may resolve an address for a PGW, e.g., PGW-B 820, for the second selected APN specified by host 805 and also establish either a GTP or a PMIPv6 tunnel to the PGW (shown as event 847).

Access router 810 may transmit a message, such as a DHCP reply message, including a hint, i.e., information about an association between the second selected APN and an address prefix of the PGW for the second selected APN to host 805 (shown as event 849). The DHCP reply message or a similar message in a different configuration protocol may include the second selected APN as well as the address prefix of the PGW for the second selected APN. Host 805 may store the association and the address prefix in the APN list in the memory. Access router 810 may transmit a message, such as a router advertisement, including the address prefix of the PGW for the second selected APN to host 805 (shown as event 851).

Host 805 may compare the address prefix received in the router advertisement with the associations stored in the APN list in the memory. If host 805 finds a match in the APN list, host 805 may associate the address prefix with the second selected APN and continues to configure the interface (shown as event 853). Host 805 may continue to configure the interface by performing an NS DAD to detect duplicate addresses as well as update neighbor caches.

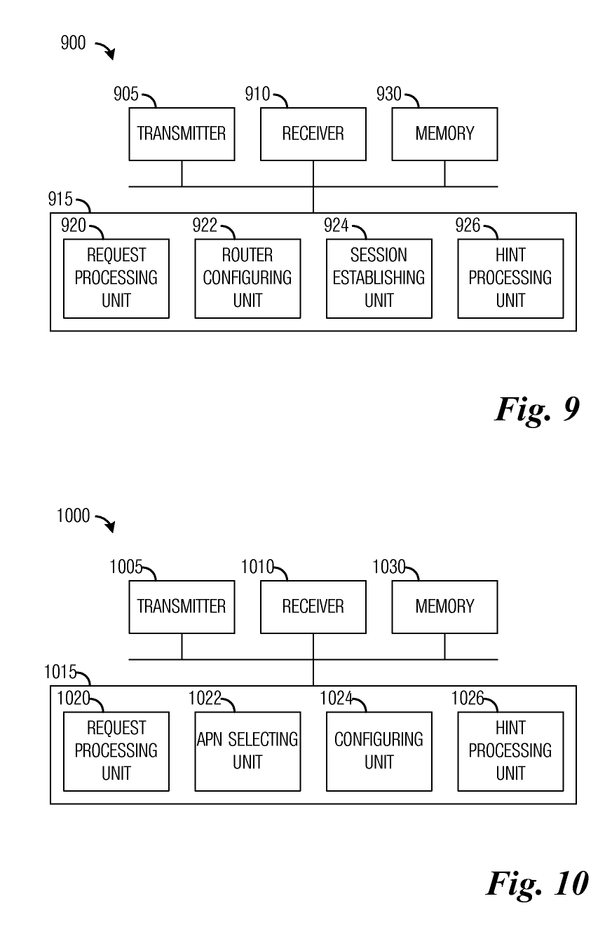

FIG. 9 illustrates a diagram of a first communications device 900. Communications device 900 may be an implementation of an access router of a communications system. Communications device 900 may be used to implement various ones of the embodiments discussed herein. As shown in FIG. 9, a transmitter 905 is configured to send messages, router interface addresses, address prefixes, hints, and the like, and a receiver 910 is configured to receive messages, router configuration requests, APN selections, and the like. Transmitter 905 and receiver 910 may have a wireless interface, a wireline interface, or a combination thereof.

A request processing unit 920 is configured to process requests, such as a request for router configuration, a request for router interface address(es), a request for session establishment, and the like. A router configuring unit 922 is configured to configure logical router interface(s) of a router to connect a host to an APN. A session establishing unit 924 is configured to establish a session between communications device 900 and a gateway router of an APN. Session establishing unit 924 is also configured to establish a tunnel between communications device 900 and the gateway router. A hint processing unit 926 is configured to generate a hint for an association between an APN and a logical router interface. A memory 930 is configured to store requests, APN information, addresses, session information, gateway router information, hints, and the like.

The elements of communications device 900 may be implemented as specific hardware logic blocks. In an alternative, the elements of communications device 900 may be implemented as software executing in a processor, controller, application specific integrated circuit, or so on. In yet another alternative, the elements of communications device 900 may be implemented as a combination of software and/or hardware.

As an example, transmitter 905 and receiver 910 may be implemented as a specific hardware block, while request processing unit 920, router configuring unit 922, session establishing unit 924, and hint processing unit 926 may be software modules executing in a processor 915, such as a microprocessor, a digital signal processor, a custom circuit, or a custom compiled logic array of a field programmable logic array. Additionally, software modules corresponding to request processing unit 920, router configuring unit 922, session establishing unit 924, and hint processing unit 926 may be stored in memory 930.

FIG. 10 illustrates a diagram of a second communications device 1000. Communications device 1000 may be an implementation of a host of a communications system. Communications device 1000 may be used to implement various ones of the embodiments discussed herein. As shown in FIG. 10, a transmitter 1005 is configured to send messages, configuration requests, APN selections, session requests, and the like, and a receiver 1010 is configured to receive messages, APN lists, addresses, address prefixes, hints, and the like. Transmitter 1005 and receiver 1010 may have a wireless interface, a wireline interface, or a combination thereof.

A request processing unit 1020 is configured to generate requests, such as a request for router configuration, a request for router interface address(es), a request for session establishment, and the like. An APN selecting unit 1022 is configured to select an APN for use by communications device 1000 out of a list of APNs. A configuring unit 1024 is configured to configure a session to a selected APN. A hint processing unit 1026 is configured to process a hint for an association between an APN and a logical router interface. Hint processing unit 1026 is also configured to store hints in a hint list, as well as search the hint list for associations. A memory 1030 is configured to store requests, APN information, APN lists, addresses, session information, gateway router information, hints, and the like.

The elements of communications device 1000 may be implemented as specific hardware logic blocks. In an alternative, the elements of communications device 1000 may be implemented as software executing in a processor, controller, application specific integrated circuit, or so on. In yet another alternative, the elements of communications device 1000 may be implemented as a combination of software and/or hardware.

As an example, transmitter 1005 and receiver 1010 may be implemented as a specific hardware block, while request processing unit 1020, APN selecting unit 1022, configuring unit 1024, and hint processing unit 1026 may be software modules executing in a processor 1015, such as a microprocessor, a digital signal processor, a custom circuit, or a custom compiled logic array of a field programmable logic array. Additionally, software modules corresponding to request processing unit 1020, APN selecting unit 1022, configuring unit 1024, and hint processing unit 1026 may be stored in memory 1030.

Although the present disclosure and its advantages have been described in detail, it should be understood that various changes, substitutions and alterations can be made herein without departing from the spirit and scope of the disclosure as defined by the appended claims.

What is claimed is:

1. A method for operating a first communications device, the method comprising:
transmitting, by the first communications device, a provisioned network list to an access router;
receiving, by the first communications device, a logical router interface address for each network in the provisioned network list;
transmitting, by the first communications device, a first message to one of the logical router interface addresses corresponding to a first selected network;
receiving, by the first communications device, a first address prefix for a first gateway router of the first selected network; and
transmitting, by the first communications device, a first packet to a second communications device, the first packet including the first address prefix as a source prefix.

2. The method of claim 1, wherein the provisioned network list and the logical router interface addresses are transmitted in configuration protocol messages.

3. The method of claim 2, wherein the configuration protocol messages comprise dynamic host configuration protocol messages.

4. The method of claim 1, wherein the first message comprises a router solicitation.

5. The method of claim 1, further comprising:
transmitting a second message to one of the logical router interface addresses corresponding to a second selected network;
receiving a second address prefix for a second gateway router of the second selected network; and
transmitting a second packet to a third communications device, the second packet including the second address prefix.

6. A method for operating an access router, the method comprising:
receiving, by the access router, a provisioned network list from a first communications device;
assigning, by the access router, a logical router interface for each network in the provisioned network list;
transmitting, by the access router, a logical router interface address for each network in the provisioned network list;
receiving, by the access router, a first message addressed to a first one of the logical router interface addresses corresponding to a selected network;
determining, by the access router, a first gateway router associated with the selected network; and
transmitting, by the access router, a first address prefix of the first gateway router to the first communications device.

7. The method of claim 6, further comprising establishing an association between each network in the provisioned network list and its corresponding logical router interface.

8. The method of claim 7, wherein determining the first gateway router associated with the selected network comprises using the established association between each network in the provisioned network list and its corresponding router interface to determine the first gateway router associated with the selected network.

9. The method of claim 6, further comprising:
obtaining the address prefix of the first gateway router for the selected network; and
establishing a session with the first gateway router using the first address prefix of the first gateway router for the selected network.

10. The method of claim 6, further comprising:
determining a second gateway router for a second selected network, when a second message received from the first communications device is addressed to a second one of the logical router interface addresses corresponding to the second selected network; and
transmitting a second address prefix for the second gateway router to the first communications device.

11. The method of claim 6, further comprising establishing a tunnel between the access router and the first gateway router.

12. A method for operating a first communications device, the method comprising:
requesting, by the first communications device, a first address prefix of a first gateway router correlating to a first specific network from an access router;
storing, by the first communications device, an association between the first address prefix and the first specific network in a memory when received from the access router;
receiving, by the first communications device, a message from the access router, the message including a second address prefix of the first gateway router for the first specific network;
searching, by the first communications device, the memory for the first address prefix that matches the second address prefix to determine the first specific network to use for transmissions; and
transmitting, by the first communications device, a packet to a second communications device via the first specific network.

13. The method of claim 12, wherein the association between the first address prefix and the first specific network comprises the first address prefix and first specific network information.

14. The method of claim 12, further comprising:
detecting a duplicate address; and
updating a neighbor cache.

15. The method of claim 14, wherein detecting the duplicate address and updating the neighbor cache comprises performing a network services duplicate address detection procedure.

16. The method of claim 12, further determining a configuration mode supported by the access router.

17. The method of claim 12, wherein the first address prefix is transmitted in a configuration protocol message.

18. The method of claim 17, wherein the configuration protocol message comprise a dynamic host configuration protocol message.

19. A method for operating an access router, the method comprising:
receiving, by the access router, a first message from a first communications device, the first message includes a specific network that the first communications device is to communicate with;
transmitting, by the access router, specific network information and a first address prefix of a gateway router correlating to the specific network to the first communications device; and
transmitting, by the access router, a message to the first communications device, the message including a second address prefix of the gateway router for the specific network.

20. The method of claim 19, further comprising resolving the gateway router for the specific network.

21. The method of claim 20, further comprising establishing a session with the gateway router.

22. The method of claim 21, further comprising establishing a tunnel between the access router and the gateway router.

23. The method of claim 19, wherein the first address prefix and the second address prefix are equal.

24. A first communications device comprising:
a transmitter configured to transmit a provisioned network list to an access router, to transmit a first message to one of a first logical router interface address out of a plurality of logical router interface addresses, the first logical router interface address corresponding to a first selected network, and to transmit a first packet to a second communications device, the first packet including a first address prefix as a source prefix; and
a receiver operatively coupled to the transmitter, the receiver configured to receive the plurality of logical router interface addresses, wherein each logical router interface address corresponds to a network in the provisioned network list, and to receive the first address prefix for a first gateway router of the first selected network.

25. The first communications device of claim 24, wherein the first message is a first configuration protocol message, and wherein the receiver is configured to receive the plurality of logical router interface addresses in a second configuration protocol message.

26. The first communications device of claim 25, wherein the first configuration protocol message and the second configuration protocol messages are dynamic host configuration protocol messages.

27. The first communications device of claim 24, wherein the transmitter is configured to transmit a second message to one of the logical router interface addresses corresponding to a second selected network, and to transmit a second packet to a third communications device, the second packet including a second address prefix, and wherein the receiver is configured to receive the second address prefix for a second gateway router of the second selected network.

28. An access router comprising:
a receiver configured to receive a provisioned network list from a first communications device, and to receive a message addressed to a first one of a plurality of logical router interface addresses corresponding to a selected network;
a processor operatively coupled to the receiver, the processor configured to assign a logical router interface to each network in the provisioned network list, and to determine a first gateway router associated with the selected network; and
a transmitter operatively coupled to the processor, the transmitter configured to transmit the plurality of logical router interface addresses for the provisioned network list, and to transmit a first address prefix for the first gateway router to the first communications device.

29. The access router of claim 28, wherein the processor is configured to establish an association between each network in the provisioned network list and its corresponding logical router interface.

30. The access router of claim 29, wherein the processor is configured to use the established association between each network in the provisioned network list and its corresponding router interface to determine the first gateway router associated with the selected network.

31. The access router of claim 28, the processor further configured to obtain the address prefix of the first gateway router for the selected network, and to establish a session with the first gateway router using the first address prefix of the first gateway router for the selected network.

32. A first communications device comprising:
a processor configured to request a first address prefix of a first gateway router correlating to a first specific network from an access router, to store an association between the first address prefix and the first specific network in a memory when received from the access router, and to search the memory for the first address prefix that matches a second address prefix to determine the first specific network to use for transmissions;
a receiver operatively coupled to the processor, the receiver configured to receive a first message from the access router, the message includes the association between the first address prefix and the first specific network, and to receive a second message from the access router, the second message including the second address prefix of the first gateway router for the first specific network; and
a transmitter operatively coupled to the processor, the transmitter configured to transmit a packet to a second communications device via the specific network.

33. The first communications device of claim 32, wherein the processor is configured to determine a configuration mode supported by the access router.

34. The first communications device of claim 32, wherein the processor is configured to perform a network services duplicate address detection procedure.

35. An access router comprising:
a receiver configured to receive a first message from a first communications device, the first message includes a specific network that the first communications device is to communicate with;
a transmitter configured to transmit specific network information and a first address prefix of a gateway router correlating to the specific network to the first communications device, and to transmit a message to the first communications device, the message including a second address prefix of the gateway router for the specific network; and
a processor operatively coupled to the receiver and to the transmitter, the processor configured to resolve the gateway router for the specific network.

36. The access router of claim 35, wherein the processor is configured to establish a tunnel between the access router and the gateway router.

37. The access router of claim 35, wherein the message is a configuration protocol message.
